(19) United States
(12) Patent Application Publication
(10) Pub. No.: US 2014/0242571 A1
(43) Pub. Date: Aug. 28, 2014

(54) OPTICAL ELEMENT, ANALYSIS EQUIPMENT, ANALYSIS METHOD AND ELECTRONIC APPARATUS

(71) Applicant: Seiko Epson Corporation, Tokyo (JP)

(72) Inventor: Mamoru SUGIMOTO, Chino (JP)

(73) Assignee: Seiko Epson Corporation, Tokyo (JP)

(21) Appl. No.: 14/189,244

(22) Filed: Feb. 25, 2014

(30) Foreign Application Priority Data
Feb. 27, 2013 (JP) 2013-036768

(51) Int. Cl. G01N 21/55; G02B 5/08; G01N 21/65

(52) U.S. Cl. CPC G01N 21/55; G01N 21/658; G02B 5/0816
USPC 435/5; 356/445; 356/301; 359/839; 435/287.1; 422/69; 436/501; 435/29

(57) ABSTRACT

An optical element includes a metal layer in which a first direction is a thickness direction; metallic particles provided to be spaced from the metal layer in the first direction; and a light transmitting layer that separates the metal layer from the metallic particles, in which the size T of the metallic particles in the first direction satisfies a relationship of 3 nm≦T≦14 nm, and the size D of the metallic particles in a second direction orthogonal to the first direction satisfies a relationship of 30 nm≦D<50 nm.

### BACKGROUND

1. Technical Field

The present invention relates to an optical element, an analysis equipment, an analysis method, and an electronic apparatus.

2. Related Art

In the fields of medicine and health, environment, food, public security or the like, a sensing technique that rapidly and simply detects a trace substance with high sensitivity and high accuracy is demanded. The trace substance that is a sensing target is extremely varied, and for example, may include biologically related substances such as bacillus, virus, protein, nucleic acid, and various antigens and antibodies, or various compounds including inorganic molecules, organic molecules and polymers. In the related art, the detection of the trace substance is performed through sampling, analysis and interpretation, but since a dedicated device and a skillful inspector are necessary, it may be difficult to perform analysis on the spot. Thus, it takes a long time (several days) to obtain an inspection result. In the sensing technique, the demand for the rapid and simple detection is very strong, and thus, it is desirable to develop a sensor capable of satisfying the demand.

For example, interest about a sensor that uses surface plasmon resonance (SPR) or a sensor that uses surface-enhanced Raman scattering (SERS) has been increased from the expectation of relatively easy integration and low influence due to an inspection and measurement environment.

As such a sensor, Japanese Patent No. 4806411 discloses a sensor having a gap type surface plasmon polariton (GSPP) structure that includes a plasmon resonance mirror formed on a substrate, a dielectric layer formed on the resonance mirror, and a plasmon resonance particle layer that is formed on the dielectric layer and is configured by a periodic array of plasmon resonance particles. In such a sensor, it is preferable that the enhancement of light based on surface plasmons (SP) excited by light irradiation be high.

According to Japanese Patent No. 4806411, the size of the plasmon resonance particles is 50 nm to 200 nm, the pitch between the particles is a value obtained by adding 0 nm to 20 nm to the size of the particles, and the thickness of the dielectric layer is 2 nm to 40 nm.

However, in the sensor including the particles and the like as described above, according to Japanese Patent No. 4806411, the effect of increasing the enhancement of light on the basis of the surface plasmons excited by light irradiation is not necessarily sufficient.

### SUMMARY

An advantage of some aspects of the invention is to provide an optical element and an analysis method in which the enhancement of light based on surface plasmons excited by light irradiation is high. Another advantage of some aspects of the invention is to provide an analysis equipment and an electronic apparatus that include the optical element.

An aspect of the invention is directed to an optical element including: a metal layer in which a first direction is a thickness direction; a metallic particle that is provided to be spaced from the metal layer in the first direction; and a light transmitting layer that separates the metallic particle from the metal layer, in which the size T of the metallic particle in the first direction satisfies a relationship of 3 nm≦T≦14 nm, and the size D of the metallic particle in a second direction orthogonal to the first direction satisfies a relationship of 30 nm≦D<50 nm.

According to the optical element with this configuration, the enhancement of light based on surface plasmons excited by light irradiation is high.

In the optical element according to this aspect of the invention, the size D may satisfy a relationship of 30 nm≦D≦40 nm.

According to the optical element with this configuration, it is possible to further increase the enhancement of light based on surface plasmons excited by light irradiation.

In the optical element according to the aspect of the invention, the size T may satisfy a relationship of 3 nm≦T≦6 nm.

According to the optical element with this configuration, it is possible to further increase the enhancement of light based on surface plasmons excited by light irradiation.

In the optical element according to the aspect of the invention, the metallic particles may be disposed in a matrix form with a pitch P in the second direction and a third direction orthogonal to the first direction and the second direction, and the pitch P may satisfy a relationship of 60 nm≦P≦140 nm.

According to the optical element with this configuration, it is possible to further increase the enhancement of light based on surface plasmons excited by light irradiation.

In the optical element according to the aspect of the invention, the light transmitting layer may include silicon oxide, and the thickness G of the light transmitting layer in the first direction may satisfy a relationship of 10 nm≦G≦150 nm or 200≦nm≦G≦350 nm.

According to the optical element with this configuration, it is possible to further increase the enhancement of light based on surface plasmons excited by light irradiation.

In the optical element according to the aspect of the invention, the light transmitting layer may be formed of a dielectric having a positive dielectric constant, a secondary peak enhancement SQRT may be equal to or higher than a primary peak enhancement SQRT, and the thickness G of the light transmitting layer in the first direction may be a thickness at the secondary peak enhancement SQRT.

According to the optical element with this configuration, as the thickness of the light transmitting layer becomes the thickness at the secondary peak enhancement SQRT at which the refractive index is stable, it is possible to reliably increase the enhancement of light based on surface plasmons excited by light irradiation.

In the optical element according to the aspect of the invention, when light having a wavelength larger than the size T and the size D is irradiated, Raman scattering light may be enhanced.

According to the optical element with this configuration, the enhancement of light based on surface plasmons excited by light irradiation is high.

Another aspect of the invention is directed to an analysis equipment including: the optical element according to the above aspect of the invention; a light source that irradiates the optical element with light; and a detector that detects light radiated from the optical element according to light irradiation from the light source.

According to the analysis equipment with this configuration, since the optical element according to the above aspect of the invention is included, it is possible to easily perform detection and measurement of a trace substance.

In the analysis equipment according to the aspect of the invention, the detector may detect Raman scattering light enhanced by the optical element.

According to the analysis equipment with this configuration, it is possible to easily perform detection and measurement of a trace substance.

In the analysis equipment according to the aspect of the invention, the light source may irradiate the optical element with light having a wavelength larger than the size T and the size D.

According to the analysis equipment with this configuration, it is possible to easily perform detection and measurement of a trace substance.

Still another aspect of the invention is directed to an analysis method including irradiating an optical element with light and detecting light radiated from the optical element according to the light irradiation to analyze a target, in which the optical element includes: a metal layer in which a first direction is a thickness direction; a metallic particle that is provided to be spaced from the metal layer in the first direction; and a light transmitting layer that separates the metallic particle from the metal layer, the size T of the metallic particle in the first direction satisfies a relationship of 3 nm≦T≦14 nm, and the size D of the metallic particle in a second direction orthogonal to the first direction satisfies a relationship of 30 nm≦D<50 nm.

According to the analysis method with this configuration, it is possible to increase the enhancement of light based on surface plasmons excited by light irradiation, and to easily perform detection and measurement of a trace substance.

Yet another aspect of the invention is directed to an electronic apparatus including: the analysis equipment according to the above aspect of the invention; an operating section that operates health care information on the basis of detection information from the detector; a storage section that stores the health care information; and a display section that displays the health care information.

According to the electronic apparatus with this configuration, since the analysis equipment according to the above aspect of the invention is included, it is possible to easily perform detection of a trace substance, and to provide health care information with high accuracy.

In the electronic apparatus according to the aspect of the invention, the health care information may include information relating to the presence or absence or amount of at least one type of biologically related substance selected from a group that includes bacillus, virus, protein, nucleic acid, and antigens and antibodies, or at least one type of compound selected from inorganic molecules and organic molecules.

According to the electronic apparatus with this configuration, it is possible to provide useful health care information.

### BRIEF DESCRIPTION OF THE DRAWINGS

The invention will be described with reference to the accompanying drawings, wherein like numbers reference like elements.

FIG. 1 is a perspective view schematically illustrating an optical element according to an embodiment.

FIG. 2 is a plan view schematically illustrating an optical element according to an embodiment.

FIG. 3 is a cross-sectional view schematically illustrating an optical element according to an embodiment.

FIG. 4 is a cross-sectional view schematically illustrating an optical element according to an embodiment.

FIGS. 5A to 5C are graphs illustrating wavelength characteristics of dielectric constants of Ag, Au and Cu.

FIGS. 6D and 6E are graphs illustrating wavelength characteristics of dielectric constants of Al and Pt.

FIG. 7 is a diagram schematically illustrating an analysis equipment according to an embodiment.

FIG. 8 is a diagram schematically illustrating an electronic apparatus according to an embodiment.

FIG. 9 is a cross-sectional view schematically illustrating a model according to an experimental example.

FIG. 10 is a graph illustrating the relationship between the thickness of an SiO₂ layer and the enhancement in a model according to an experimental example.

FIG. 11 is a graph illustrating the relationship between an excitation wavelength and the enhancement in a model according to an experimental example.

FIG. 12 is a graph illustrating the relationship between the diameter and thickness of Ag particles and the enhancement in the model according to the experimental example.

FIG. 13 is a graph illustrating the relationship between an excitation wavelength and the enhancement in a model according to an experimental example.

FIG. 14 is a graph illustrating the relationship between an excitation wavelength and the enhancement in a model according to an experimental example.

FIG. 15 is a graph illustrating the relationship between an excitation wavelength and the enhancement in a model according to an experimental example.

FIG. 16 is a graph illustrating the relationship between an excitation wavelength and the enhancement in a model according to an experimental example.

FIG. 17 is a graph illustrating the relationship between an excitation wavelength and the enhancement in a model according to an experimental example.

FIG. 18 is a graph illustrating the relationship between the pitch of Ag particles and the enhancement in a model according to an experimental example.

FIGS. 19A to 19C are graphs illustrating the relationship between an excitation wavelength and reflectance in a model according to an experimental example.

### DESCRIPTION OF EXEMPLARY EMBODIMENTS

Hereinafter, preferred embodiments of the invention will be described with reference to the accompanying drawings. The embodiments described below do not improperly limit the content of the invention disclosed in the appended claims. Further, the entire components described below are not limited as essential components of the invention.

### 1. OPTICAL ELEMENT

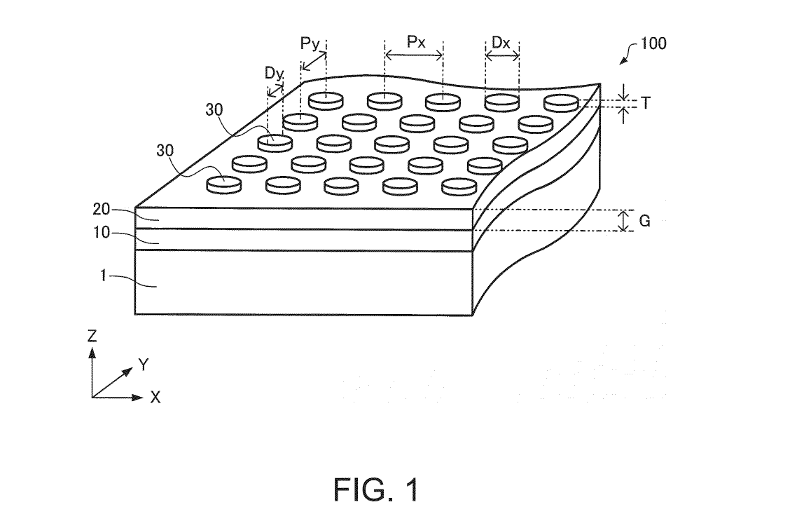

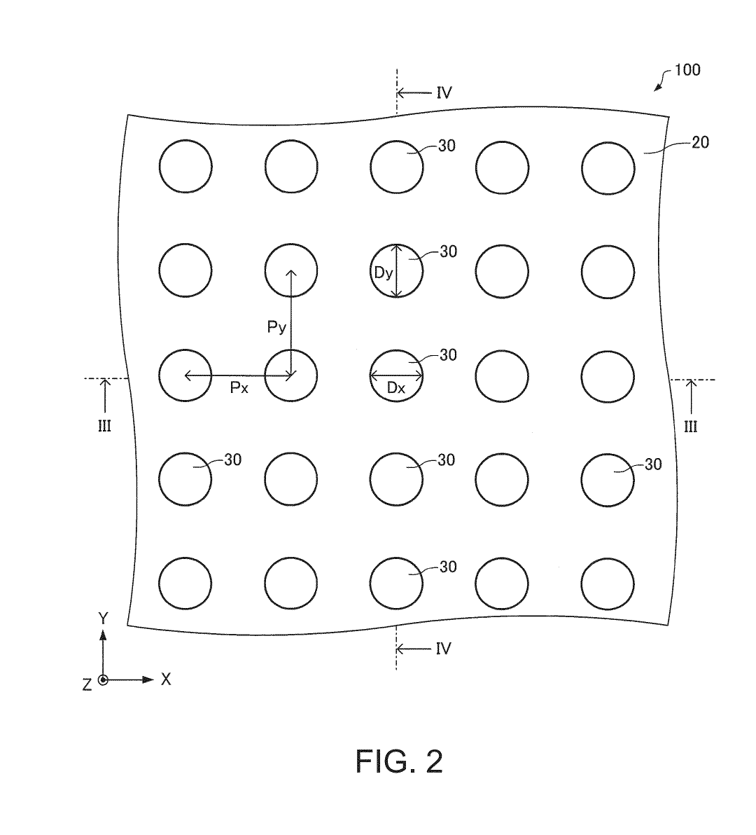

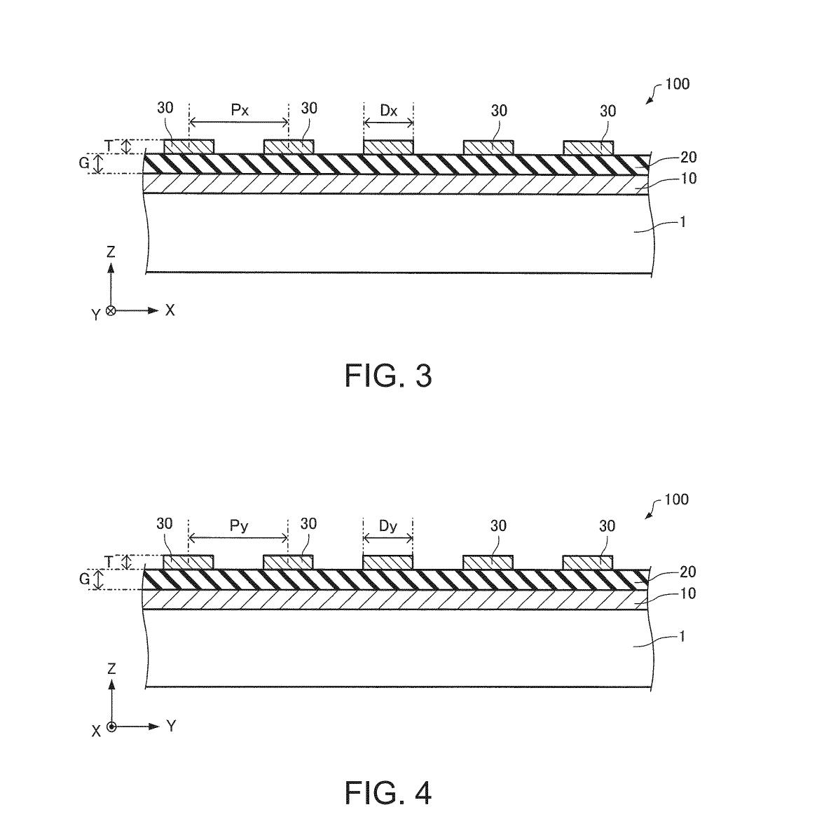

First, an optical element according to an embodiment will be described with reference to the accompanying drawings. FIG. 1 is a perspective view schematically illustrating an optical element 100 according to an embodiment. FIG. 2 is a plan view schematically illustrating the optical element 100 according to the present embodiment. FIG. 3 is a cross-sectional view taken along line III-III in FIG. 2 that schematically illustrates the optical element 100 according to the present embodiment. FIG. 4 is a cross-sectional view taken along line IV-IV in FIG. 2 that schematically illustrates the optical element 100 according to the present embodiment.

In FIGS. 1 to 4 and FIG. 8 to be described later, an X axis, a Y axis and a Z axis are shown as three axes that are orthogonal to each other. Further, hereinafter, a direction parallel with the X axis is called an X-axis direction (a second direction), a direction parallel with the Y axis is called a Y-axis direction (a third direction), and a direction parallel with the Z axis is called a Z-axis direction (a first direction).

The optical element 100 includes a metal layer 10 and metallic particles 30, as shown in FIGS. 1 to 4. Further, the optical element 100 may include a substrate 1 and a light transmitting layer 20.

### 1.1. Metal Layer

The shape of the metal layer 10 is not particularly limited as long as it provides a metallic surface that does not transmit light, and for example, may have a thick plate shape or may have a film, layer or membrane shape. The metal layer 10 may be provided on the substrate 1, for example. As the substrate 1, for example, a glass substrate, a silicon substrate, a resin substrate or the like may be used. The shape of a surface of the substrate 1 on which the metal layer 10 is provided is not particularly limited. When the surface of the metal layer 10 is formed with an ordered structure, the substrate 1 may have a surface corresponding to the ordered structure, and when the surface of the metal layer 10 is formed to be flat, the substrate 1 may have a flat surface (plane). In the example shown in the figures, the metal layer 10 is provided on the surface (plane) of the substrate 1.

Here, the term “plane” is used, but this does not mean that the surface indicates a mathematically strict flat (smooth) plane without slight irregularity. For example, irregularities due to atoms that form the plane, irregularities due to a secondary structure (crystal, grain aggregate, grain boundary or the like) of substances that form the plane, or the like may be present on the surface, and thus, from a microscopic point of view, the plane may not be a strict plane. However, even in such a case, from a macroscopic point of view, these irregularities become inconspicuous and are thus observed to a degree that there is no problem in that the surface is called the plane. Accordingly, in this specification, if the surface can be recognized as the plane from the macroscopic point of view, the surface is called the plane.

Further, in this specification, a thickness direction of the metal layer 10 is defined as the Z-axis direction (the first direction). For example, when the metal layer 10 is provided on the surface of the substrate 1, a normal direction of the surface of the substrate 1 is the Z-axis direction.

The metal layer 10 may be formed by deposition, sputtering, casting, machining or the like. The metal layer 10 may be formed on the entire surface of the substrate 1, or may be provided on a part of the surface of the substrate 1. The thickness of the metal layer 10 may be set to 10 nm to 1 mm, preferably 20 nm to 100 μm, and more preferably 30 nm to 1 μm, for example.

The metal layer 10 is formed of a metal in which an electric field is present so that an electric field given by incident light and polarization induced by the electric field oscillate in reverse phases, that is, a metal in which a real part of a dielectric function has a negative value (a negative dielectric constant) and a dielectric constant of an imaginary part thereof may be smaller than an absolute value of the dielectric constant of the real part. As an example of the metal capable of having such a dielectric constant in a visible light region, gold, silver, aluminum, copper, an alloy thereof or the like may be used. Further, the surface (an end section in the first direction) of the metal layer 10 may be or may not be a specific crystalline plane. Nano particles may be formed in an artificial manner in the metal layer 10, and localized surface plasmons may be excited between the nano particles and the metallic particles 30.

### 1.2. Light Transmitting Layer

The light transmitting layer 20 is provided on the metal layer 10, and is provided between the metal layer 10 and the metallic particles 30. The light transmitting layer 20 separates the metal layer 10 from the metallic particles 30. The light transmitting layer 20 may have a film, layer or membrane shape. The light transmitting layer 20 may space the metal layer 10 from the metallic particles 30.

The light transmitting layer 20 may be formed by deposition, sputtering, chemical vapor deposition (CVD), various coating techniques or the like. The light transmitting layer 20 may be formed on the entire surface of the metal layer 10, or may be provided on a part of the surface of the metal layer 10. In the light transmitting layer 20, the Z-axis direction is a thickness direction thereof.

The thickness G of the light transmitting layer 20 may satisfy the relationship of 10 nm≦G≦150 nm or 200 nm≦G≦350 nm when the light transmitting layer 20 is formed as an SiO₂ layer. Thus, the optical element 100 may increase the enhancement of light (details thereof will be described later with reference to experimental examples).

Further, the enhancement SQRT of a secondary peak may be equal to or greater than the enhancement SQRT of a primary peak, and the thickness G of the light transmitting layer 20 may be a thickness in the enhancement SQRT of the secondary peak. That is, the thickness G of the light transmitting layer 20 may be a thickness when the enhancement SQRT of the secondary peak is provided. Definition or the like of the primary peak and the secondary peak will be described later.

The light transmitting layer 20 includes silicon oxide (SiO₂). The light transmitting layer 20 may have a positive dielectric constant, and its material may be SiO₂, or may be Al₂O₃, TiO₂, Ta₂O₅, Si₃N₄, MgF, ITO or polymer. Further, the light transmitting layer 20 may be configured by plural layers having different materials, or may be configured by a composite membrane.

### 1.3. Metallic Particles

The metallic particles 30 are provided spaced from the metal layer 10 in the Z-axis direction. In the example shown in the figures, as the light transmitting layer 20 is provided on the metal layer 10 and the metallic particles 30 are formed thereon, the metal layer 10 and the metallic particles 30 are disposed spaced from each other in the Z-axis direction.

The shape of the metallic particle 30 is not particularly limited, and may be a circular shape, an elliptical shape, a polygonal shape, an undefined form or a combination thereof when the particle is projected in the Z-axis direction (in a plan view in the Z-axis direction). In the example shown in the figures, the metallic particle 30 is a circular column shape having a central axis in the Z-axis direction, and the planar shape (the shape seen in the Z-axis direction) of the metallic particle 30 is a circular shape.

The size Dx of the metallic particle 30 in the X-axis direction represents the length of a section where the metallic particle 30 can be divided by a plane perpendicular to the X-axis, and satisfies the relationship of 30 nm≦Dx<50 nm. Further, Dx may satisfy the relationship of 30 nm≦Dx≦40 nm. The size Dy of the metallic particle 30 in the Y-axis direction represents the length of a section where the metallic particle 30 can be divided by a plane perpendicular to the Y-axis, and satisfies the relationship of 30 nm≦Dy<50 nm. Further, Dy may satisfy the relationship of 30 nm≦Dy≦40 nm.

In the example shown in the figures, Dx and Dy have the same size D, and thus, represent the diameter of the metallic particle 30 (the diameter of the bottom of the metallic particle 30 of the circular column shape). That is, the diameter D may satisfy the relationship of 30 nm≦D<50 nm, and more preferably 30 nm≦D≦40 nm. Thus, the optical element 100 may increase the enhancement of light (details thereof will be described later with reference to the experimental examples).

The size T of the metallic particle 30 in the Z-axis direction may satisfy the relationship of 3 nm≦T≦14 nm, preferably 3 nm≦T≦7 nm, and more preferably 3 nm≦T≦6 nm. Thus, the optical element 100 may increase the enhancement of light (details thereof will be described later with reference to the experimental examples). In the example shown in the figures, T represents the thickness (height) of the metallic particle 30.

Plural metallic particles 30 are provided. The metallic particles 30 are disposed in the X-axis direction with a pitch Px, and are disposed in the Y-axis direction with a pitch Py. In the example shown in the figures, Px and Py have the same size P. That is, the metallic particles 30 are disposed in a matrix shape with the same pitch P in the X-axis direction and the Y-axis direction. P may satisfy the relationship of 60 nm≦P≦140 nm, and preferably 100 nm≦P≦140 nm.

The term “pitch Px” refers to the distance between the centers of gravity of the adjacent metallic particles 30 in the X-axis direction. Similarly, the term “pitch Py” refers to the distance between the centers of gravity of the adjacent metallic particles 30 in the Y-axis direction.

The metallic particle 30 is formed of a metal that has a negative dielectric constant, in which a dielectric constant of an imaginary part may be smaller than an absolute value of a dielectric constant of a real part thereof, similar to the metal layer 10. Further, it is preferable that the dielectric constant of the imaginary part come close to zero, in which energy loss is decreased when electrons are subjected to plasma oscillation and the enhancement effect is increased. More specifically, as a material of the metallic particle 30, for example, gold, silver, aluminum, copper, an alloy thereof, or a multi-layer structure thereof may be used.

The metallic particles 30 may be formed by performing patterning after forming a thin membrane by sputtering, deposition or the like, or may be formed by micro contact printing lithography, nanoimprint lithography or the like. Further, the metallic particles 30 may be formed by a colloidal chemical method, and may be disposed at a position spaced from the metal layer 10 by an appropriate method.

The metallic particle 30 has a function of generating a localized surface plasmon (LSP). By irradiating incident light to the metallic particle 30 under a predetermined condition, it is possible to generate the localized surface plasmon around the metallic particle 30.

### 1.4. Localized Surface Plasmon

When light is irradiated to the metallic particle 30, free electrons in the metallic particle 30 are collectively oscillated to generate electric polarization, and an anti-polarization electric field is generated by surface charges associated with the electric polarization. The anti-polarization electric field refers to an electric field in a reverse direction with respect to an external electric field, generated in the metallic particle 30 when the external electric field is applied to the metallic particle 30. The anti-polarization electric field affects the free electrons, and thus, an oscillation mode of the free electrons is changed. Thus, oscillation specific to the metallic particle 30 is excited. The oscillation specific to the metallic particle 30 corresponds to the localized surface plasmon.

The localized surface plasmon is a plasmon localized in a near-field region of the metallic particle 30, and thus, has a high strength. Particularly, if there are plural metallic particles 30 and the pitch between the adjacent metallic particles 30 satisfies a predetermined value, a particularly strong plasmon is excited between the adjacent metallic particles 30. Consequently, light energy becomes plasmons on the surface of the metallic particle 30 to be strongly collected in a very narrow region (hot spot). In the region where the plasmons are present, interaction between light and molecules is strongly amplified, which causes SERS that strongly amplifies Raman scattering light.

The hot spot is generated in a polarization direction of the incident light in the metallic particle 30. That is, when the incident light has a component that is polarized in the X-axis direction, the hot spot is generated in the X-axis direction of the metallic particle 30. Here, when the incident light has the component polarized in the X-axis direction, if the wavelength of the incident light is larger than the thickness of the metallic particle 30 and the size Dx in the X-axis direction, the localized surface plasmon is excited. That is, if light having a wavelength larger than the thickness of the metallic particle 30 and the size Dx in the X-axis direction is irradiated, the localized surface plasmon is excited. Further, if the pitch Px of the adjacent metallic particles 30 in the X-axis direction is equal to or smaller than the wavelength of the incident light, the strength of the localized surface plasmons is further increased.

In this specification, the term “strength of plasmons” refers to the enhancement of light based on surface plasmons (that are mainly localized surface plasmons) excited by light irradiation, and specifically, refers to the electric field strength of the hot spot.

The surface plasmons are present in a wavelength of light where a real part of a dielectric function (dielectric constant) of the metal that forms the metallic particle 30 has a negative value. Here, “the real part of the dielectric function (dielectric constant) having the negative value” corresponds to the oscillation of the external electric field generated in the metallic particle 30 and the polarization induced by the external electric field in the reverse phases, in which any metal in which the imaginary part ∈2 of the dielectric constant is smaller than the absolute value of the real part ∈1 of the dielectric constant at a certain wavelength may excite the surface plasmons. Further, if the imaginary part ∈2 of the dielectric constant comes close to zero, plasma oscillation loss of electrons is reduced, and the enhancement becomes infinite. That is, the material from which the plasmons are excited may have a high plasmon strength when the real part ∈1 of the dielectric constant has a large negative value and the imaginary part ∈2 comes close to zero.

More specifically, a condition that the localized surface plasmon is generated in the metallic particles 30 is given by Real[∈(ω)]=−2∈ by the real part of the dielectric constant. If a peripheral refractive index n is set to 1, the real part of the dielectric constant is ∈1=n²−κ²=1, and thus, Real[∈(ω)]=−2. Here, W represents an angular frequency of incident light incident on the metallic particle 30, ∈(ω) represents a dielectric constant of a metal that forms the metallic particle 30, and ∈ represents a peripheral dielectric constant. The imaginary part ∈2 of the dielectric constant is given by ∈2=2nκ.

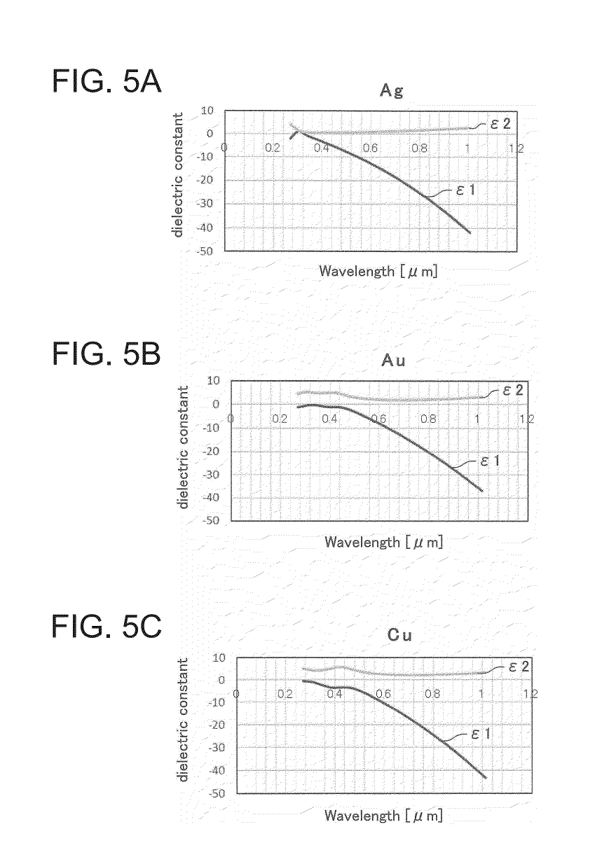

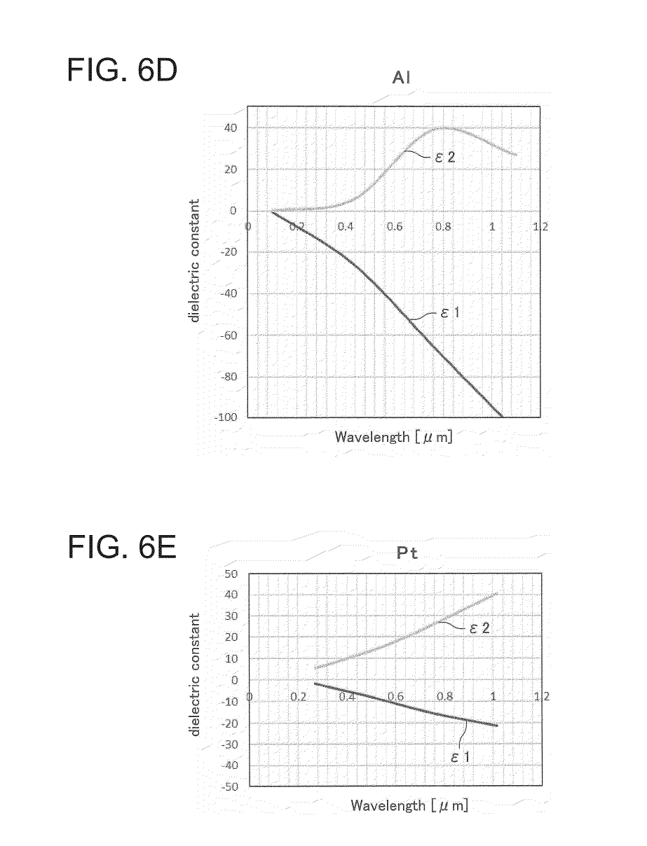

FIGS. 5A to 5C show wavelength characteristics of dielectric constants of Ag, Au and Cu metals. Further, FIGS. 6D and 6E show wavelength characteristics of dielectric constants of Al and Pt metals. The metal and wavelength that satisfy the plasmon excitation condition include Ag having a wavelength of 350 nm or longer, Au having a wavelength of 500 nm or longer, Cu having a wavelength of 550 nm or longer, and Al having a wavelength of 420 nm or shorter. In the respective metals having these wavelengths, the plasmon is excited. The imaginary part ∈2 of Ag is closest to zero. On the other hand, Pt has a large value of the imaginary part ∈2, and the plasmon may not be excited in a wavelength band from ultraviolet to infrared. As shown in FIG. 5A, in a wavelength of at least 350 nm or longer, the absolute value of ∈2 is smaller than the absolute value of ∈1. That is, when the material of the metallic particle 30 is silver, if the localized surface plasmon is excited, it is necessary to irradiate the metallic particle 30 with light of a wavelength of 350 nm or longer.

A wavelength where Ag satisfies Real[∈(ω)]=−2 is around 370 nm in FIG. 5A, but as described above, in a case where the plural metallic particles 30 (Ag particles) have sizes close to the nano-order, or in a case where the metallic particles 30 and the metal layer 10 (Au membrane or the like) are disposed spaced from each other by the light transmitting layer 20, an excitation peak wavelength of the localized surface plasmon is red-shifted (shifted to the long wavelength side) due to the influence of a gap. The amount of shift depends on dimensions such as the diameters Dx and Dy of the metallic particle 30, the thickness T of the metallic particle 30, the pitches Px and Py of the metallic particle 30 and the thickness G of the light transmitting layer 20, and for example, shows wavelength characteristics in which the localized surface plasmon forms the peak at 500 nm to 1200 nm.

### 1.5. Coat Layer

The optical element 100 may have a coat layer as necessary. Although not shown, the coat layer may be formed to cover the metallic particles 30. Further, the coat layer may be formed to cover the other configuration while exposing the metallic particles 30.

The coat layer has a function of mechanically and chemically protecting the metallic particle 30 or the other configuration from an environment, for example. Further, the coat layer may also have a function of fixing a trace substance that is a sensing target. The coat layer may be formed by deposition, sputtering, CVD, various coating techniques or the like. A material of the coat layer is not particularly limited. For example, the coat layer may be formed of an insulator such as SiO₂, Al₂O₃, TiO₂, Ta₂O₅ or Si₃N₄, may be formed by a transparent conductive film made of ITO or the like, or may be formed of metal such as Cu or Al, polymer or the like. The thickness thereof is preferably several nanometers thin.

The optical element 100 has the following characteristics, for example.

In the optical element 100, the size T of the metallic particle 30 in the Z-axis direction satisfies the relationship of 3 nm≦T≦14 nm, and the size Dx (D) of the metallic particle 30 in the X-axis direction satisfies the relationship of 30 nm≦D<50 nm. Thus, in the optical element 100, the enhancement of light based on the surface plasmon excited by light irradiation is high (details thereof will be described later with reference to the experimental examples). Thus, the optical element 100 may be used for a sensor for rapidly and simply detecting biologically related substances such as bacillus, virus, protein, nucleic acid and various antigens and antibodies, and various compounds that include inorganic molecules, organic molecules and polymer with high sensitivity and high accuracy, in the field of medical treatment and health, environment, food, and public safety. For example, the enhancement at the time when antibodies are combined with the metallic particles 30 of the optical element 100 and the enhancement at the time may be calculated, and the presence or absence of antigens or the amount thereof may be checked on the basis of change in the enhancement at the time when the antigens are combined with the antibodies. Further, it is possible to use the optical element 100 for enhancement of Raman scattering light of a trace substance using the enhancement of the light of the optical element 100.

In the optical element 100, the size D of the metallic particle 30 may satisfy the relationship of 30 nm≦D≦40 nm, the thickness T of the metallic particle 30 may satisfy the relationship of 3 nm≦T≦6 nm, the pitch P of the metallic particle 30 may satisfy the relationship of 60 nm≦P≦140 nm, and the thickness G of the light transmitting layer 20 may satisfy, when the light transmitting layer is the SiO₂ layer, the relationship of 10 nm≦G≦150 nm or 200 nm≦G≦350 nm. Thus, in the optical element 100, it is possible to further increase the enhancement of the light based on the surface plasmon excited by light irradiation (details thereof will be described later with reference to the experimental examples).

### 2. ANALYSIS EQUIPMENT

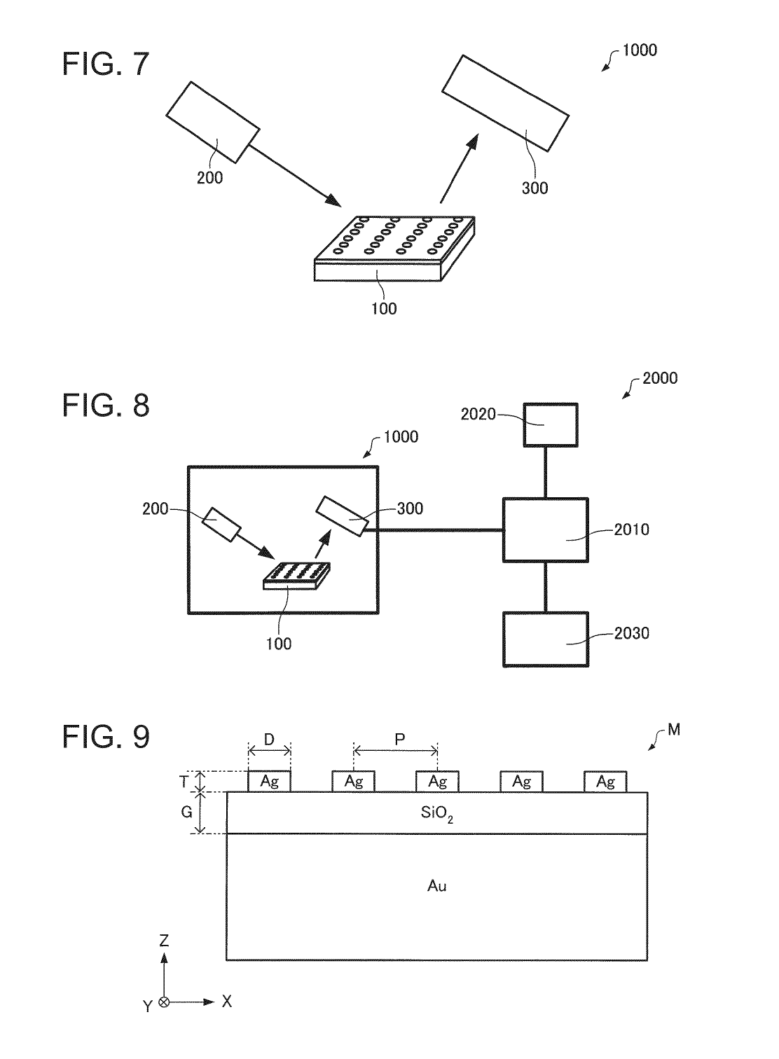

Next, an analysis equipment 1000 according to an embodiment of the invention will be described with reference to the accompanying drawings. FIG. 7 is a diagram schematically illustrating main parts of the analysis equipment 1000 according to the present embodiment. The analysis equipment 1000 may include an optical element according to the present embodiment. Hereinafter, the analysis equipment 1000 that includes the optical element 100 as the optical element according to the present embodiment will be described.

As shown in FIG. 7, the analysis equipment 1000 includes the optical element 100, a light source 200 that emits incident light, and a detector 300 that detects light radiated from the optical element 100. The analysis equipment 1000 may include other appropriate components (not shown).

The optical element 100 functions to enhance light and serves as a sensor in the analysis equipment 1000. The optical element 100 is used in contact with a sample that is an analysis target of the analysis equipment 1000. Arrangement of the optical element 100 in the analysis equipment 1000 is not particularly limited, and the optical element 100 may be installed on a stage or the like where an installation angle or the like is adjustable.

The light source 200 irradiates the optical element 100 with the incident light. The light source 200 irradiates the optical element 100 with light of a wavelength larger than the thickness T of the metallic particle 30 and the sizes Dx and Dy of the metallic particle 30. An incident angle θ of the incident light emitted from the light source 200 may be appropriately changed according to excitation conditions of surface plasmons of the optical element 100. The light source 200 may be installed in a goniometer or the like.

The light emitted from the light source 200 is not particularly limited as long as it can excite the surface plasmons of the optical element 100, and may be provided as electromagnetic waves that include ultraviolet light, visible light and infrared light. The light emitted from the light source 200 may have a polarizing component in a direction where the size of the metallic particle 30 is equal to 30 nm or larger and smaller than 50 nm. More specifically, the light emitted from the light source 200 has a polarizing component in the X-axis direction. Further, the light emitted from the light source 200 may have a polarizing component in the Y-axis direction. Further, the light emitted from the light source 200 may be or may not be coherent light. Specifically, as the light source 200, a semiconductor laser, a gas laser, a halogen lamp, a high-pressure mercury lamp, a xenon lamp or the like may be used.

The light from the light source 200 serves as incident light, and enhanced light is radiated from the optical element 100. Thus, it is possible to perform amplification of Raman scattering light of the sample or detection of the substance interacting with the optical element 100.

The detector 300 detects the light radiated from the optical element 100 according to irradiation of the light from the light source 200. Specifically, the detector 300 may detect the Raman scattering light enhanced by the optical element 100. As the detector 300, for example, a charge coupled device (CCD), a photo multiplier, a photodiode, an imaging plate or the like may be used.

The detector 300 may be provided at a position where the light radiated from the optical element 100 can be detected, and the positional relationship with the light source 200 is not particularly limited. Further, the detector 300 may be installed in a goniometer or the like.

The analysis equipment 1000 includes the optical element 100 in which the enhancement of the light based on the surface plasmons excited by light irradiation is high. Thus, the analysis equipment 1000 can easily detect and measure a trace substance.

### 3. ANALYSIS METHOD

Next, an analysis method according to an embodiment of the invention will be described with reference to the accompanying drawings. The analysis method according to the present embodiment may use an analysis equipment according to the present embodiment. Hereinafter, the analysis method that uses the analysis equipment 1000 as the analysis equipment according to the present embodiment will be described.

The analysis method according to the present embodiment is an analysis method of introducing a substance that includes an analysis target in a detection region of the optical element 100, as shown in FIG. 7, irradiating the optical element 100 with incident light, detecting light radiated from the optical element 100 according to irradiation of the incident light, and analyzing the target attached to the surface of the optical element 100.

The analysis method according to the present embodiment uses the optical element 100 in which the enhancement of the light based on the surface plasmons excited by light irradiation is high. Thus, it is possible to easily detect and measure a trace substance.

### 4. ELECTRONIC APPARATUS

Next, an electronic apparatus 2000 according to an embodiment of the invention will be described with reference to the accompanying drawings. FIG. 8 is a diagram schematically illustrating the electronic apparatus 2000 according to the present embodiment. The electronic apparatus 2000 may include an analysis equipment according to the present embodiment. Hereinafter, the electronic apparatus 2000 that includes the analysis equipment 1000 as the analysis equipment according to the present embodiment will be described.

As shown in FIG. 8, the electronic apparatus 2000 includes the analysis equipment 1000, an operating section 2010 that operates health care information on the basis of detection information from the detector 300, a storage section 2020 that stores the health care information, and a display section 2030 that displays the health care information.

The operating section 2010 is, for example, a personal computer or a personal digital assistant (PDA), which receives detection information (signal or the like) transmitted from the detector 300 and performs operation based on the received detection information. Further, the operating section 2010 may control the analysis equipment 1000. For example, the operating section 2010 may control an output, the position or the like of the light source 200 of the analysis equipment 1000, or may control the position of a detector 400. The operating section 2010 may operate the health care information on the basis of the detection information from the detector 300. Further, the health care information operated by the operating section 2010 is stored in the storage section 2020.

The storage section 2020 is a semiconductor memory, a hard disk drive, for example, and may be integrally formed with the operating section 2010. The health care information stored in the storage section 2020 is transmitted to the display section 2030.

The display section 2030 is configured by a display plate (liquid crystal monitor or the like), a printer, an emitter, a speaker or the like. The display section 2030 performs display or notification so that a user can recognize the content on the basis of the health care information or the like operated by the operating section 2010.

The health care information may include information relating to the presence or absence or the amount of at least one type of biologically related substance selected from a group that includes bacillus, virus, protein, nucleic acid and antigens and antibodies, or at least one type of compound selected from inorganic molecules and organic molecules.

The electronic apparatus 2000 includes the optical element 100 in which the enhancement of the light based on the surface plasmons excited by light irradiation is high. Thus, the electronic apparatus 2000 can easily detect a trace substance, and can provide health care information with high accuracy. Further, the electronic apparatus 2000 can provide useful health care information.

### 5. EXPERIMENTAL EXAMPLES

Hereinafter, the invention will be more specifically described with reference to experimental examples, but the invention is not limited thereto. The following examples are simulations using a calculator.

### 5.1. Calculation Model

FIG. 9 is a cross-sectional view schematically illustrating a basic structure of a model Mused for simulation. As shown in FIG. 8, the model M used for calculation of the experimental examples was manufactured configured by forming an SiO₂ layer (light transmitting layer) on an Au layer (metal layer) that is sufficiently thick so as not to transmit light, and forming Ag particles (metallic particles) on the SiO₂ layer. The shape of the Ag particle was a circular column shape in which the Z-axis direction was a central axis thereof, and plural Ag particles are disposed in a matrix form in the X-axis direction and the Y-axis direction with the same pitch P.

In the present experimental examples, the calculation was performed using FDTD soft Fullwave made by Cybernet Systems Co., Ltd. Further, a condition of a used mesh was a minimum mesh of 1 nm, and a calculation time cT was 10 μm. Further, a peripheral refractive index was 1, incident light was incident vertically in the Z-axis direction and then was linearly polarized in the X-axis direction.

In the present experimental examples, in the above-described model M, the thickness T (the size in the Z-axis direction) of the Ag particle, the diameter D (the diameter of the bottom, that is, the size in the X-axis direction and the size in the Y-axis direction) of the Ag particle, the pitch P of the Ag particles, and the thickness G (the size in the Z-axis direction) of the SiO₂ layer were changed to calculate the enhancement.

In the present experimental examples, the term “enhancement” refers to the ratio of the intensity of light radiated from the model M to the intensity of light incident on the model M, and is expressed as SQRT (Ex²+Ez²). The enhancement was obtained by calculating a near field characteristic in the model M, but it was found that there was a case where the direction of an electric field vector was noticeably changed even though a hot spot (maximum enhancement position), that is, the position of YeeCell shifted by only half the minimum mesh size. Thus, when the electric field was expressed by scalar, it was found that the influence of the position of YeeCell was reduced. Here, Ex represents the electric field enhancement in the X-axis direction, and Ez represents the electric field enhancement in the Z-axis direction. In this case, the electric field enhancement in the Y-axis direction is small, and thus is not considered.

### 5.2. Experimental Example 1

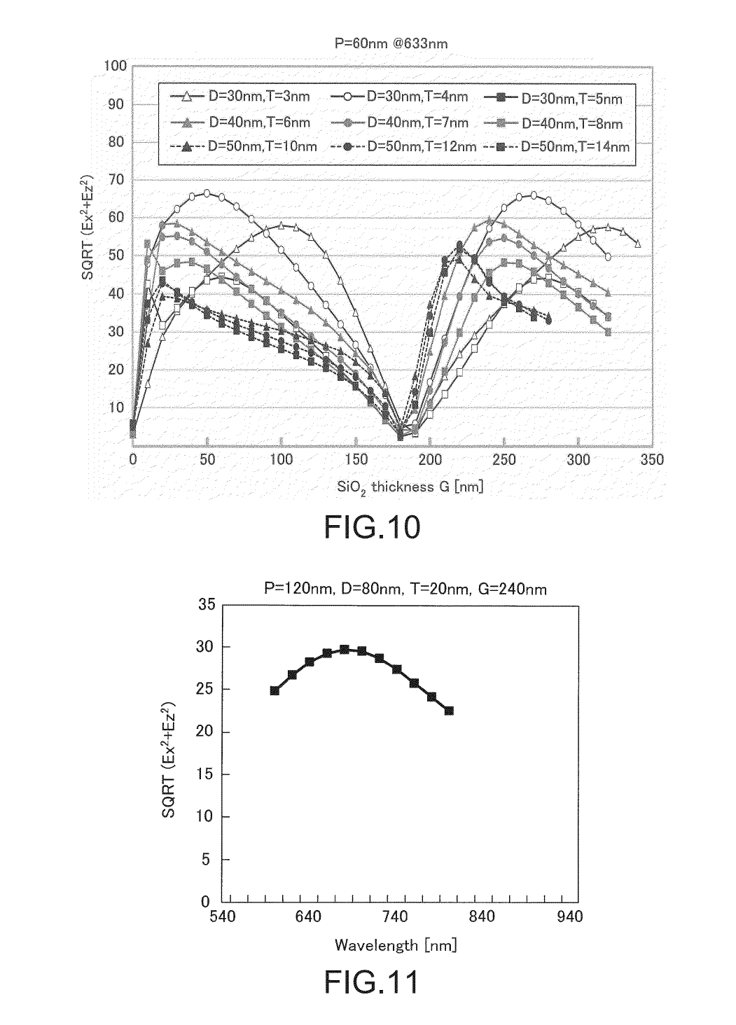

The pitch P of the Ag particles was fixed to 60 nm, and the excitation wavelength (the wavelength of light for exciting plasmons, that is, the wavelength of light incident on the Ag particles) was fixed to 633 nm. Further, the diameter D of the Ag particle was set to 30 nm, 40 nm and 50 nm, the thickness T of the Ag particle was set to 3 nm to 4 nm, 6 nm to 8 nm, and 10 nm to 14 nm, respectively. Then, the relationship between the thickness G of the SiO₂ layer and the enhancement was checked. The result is shown in FIG. 10. The reason why the thickness T is changed for each diameter D is because the wavelength at which the enhancement becomes peak as the diameter D and the thickness T of the Ag particle are changed. Since the excitation wavelength in the calculation is 633 nm, by assigning the thickness T for each diameter D, a combination of dimensions that obtains the highest enhancement becomes peak at 633 nm.

Returning to FIG. 10, when the material of the light transmitting layer is SiO₂, an example is shown in which the enhancement is increased in the range of 10 nm≦G≦150 nm, or 200 nm≦G≦350 nm.

The condition that the enhancement SQRT with respect to the thickness G of a light transmitting spacer using an interference effect is increased is that the thickness G of the light transmitting layer, the refractive index n and the wavelength λ satisfy G≅m·λ/(2·n) where m=±1, ±2, . . . . When m=1, since G=λ/(2·n), if λ=633 nm, n=1.45 are substituted, G=218 nm. This is approximately the same as the thickness G of the light transmitting layer indicating the peak when D=50 nm, T=10 nm, 12 nm and 14 nm. On the other hand, when D=30 nm and T=4 nm, the secondary peak is taken when G=270, which may be explained by the fact that the effective refractive index is reduced to n_{eff}=633/(2×270)=1.17. The effective refractive index is reduced as an aperture area is enlarged (from P=60 nm and D=50 nm to P=60 nm and D=30 nm).

From the above description, when the light transmitting layer is formed by an Al₂O₃ layer having a refractive index of 1.76 or a TiO₂ layer having a refractive index of 2.52 larger than the refractive index 1.45 of the SiO₂ layer, the enhancement peak with respect to the thickness G of the light transmitting layer that is inversely proportional to the size of the refractive index of the light transmitting layer shifts to the side where the thickness G of the light transmitting layer is thin. However, effects due to the primary peak and the secondary peak of the thickness of the light transmitting layer are the same. That is, there is a new finding that the primary peak SQRT (Ex²+EZ²)≦the secondary peak SQRT (Ex²+EZ²) is established. That is, the light transmitting layer is a dielectric having a positive dielectric constant, in which the secondary peak enhancement SQRT is larger than or equal to the primary peak enhancement SQRT.

The primary peak is a peak of the enhancement that appears on the side where the thickness G of the light transmitting layer is small, and the secondary peak is a peak of the enhancement that appears on the side where the thickness G of the light transmitting layer is large.

Further, as shown in FIG. 10, the peak value of the enhancement is equal to or greater than 30 in the range of 3 nm≦T≦14 nm. For example, in the model shown in FIG. 11 where P=120 nm, D=80 nm, T=20 nm and G=240 nm, the enhancement is equal to or lower than 30. Accordingly, in the range of 3 nm≦T≦14 nm, the peak value of the enhancement is increased. In FIG. 11, the relationship between the excitation wavelength and the enhancement is shown. Further, it can be understood from FIG. 10 that the enhancement is increased in the range of 3 nm≦T≦7 nm, and is further increased in the range of 3 nm≦T≦6 nm.

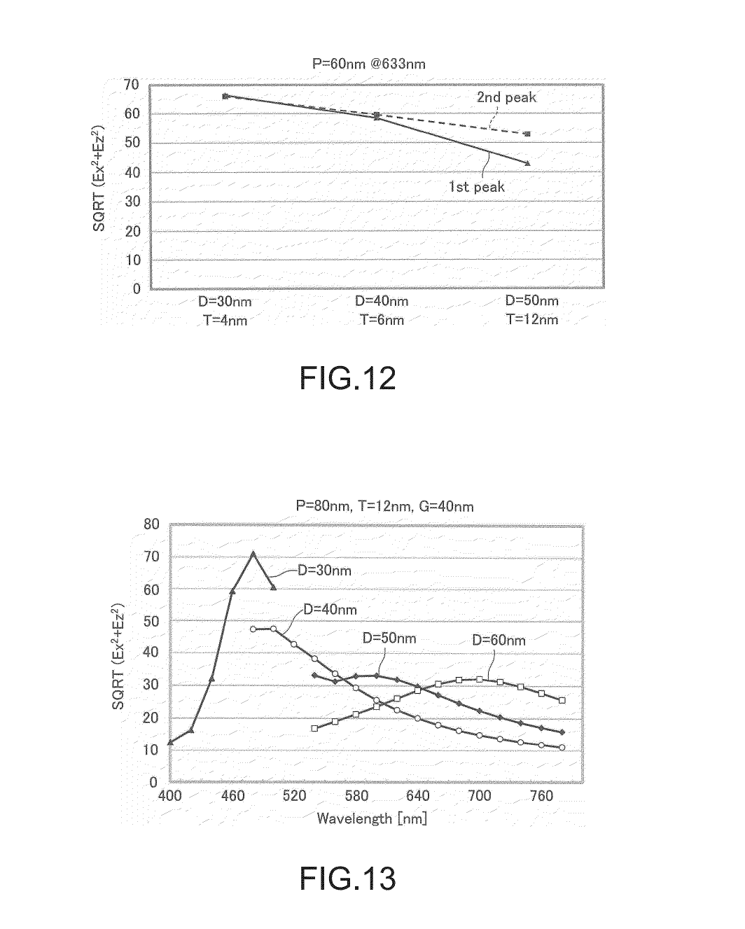

Here, FIG. 12 is a graph obtained by plotting the enhancements of the models in which the highest enhancements are obtained in the respective diameters D (=30 nm, 40 nm and 50 nm) in FIG. 10. In FIG. 11, the “primary peak” represents a primary peak value in the range of 10 nm≦G≦150 nm in FIG. 10, and the “secondary peak” represents a secondary peak value in the range of 200 nm≦G≦350 nm in FIG. 10.

It is understood from FIG. 12 that the models of D=30 nm and 40 nm have enhancements higher than that of the model of D=50 nm. Particularly, it is understood that the drop of the primary peak value is larger than that of the secondary peak value in the model of D=50 nm compared with the models of D=30 nm and 40 nm. That is, it is understood that the enhancement is further increased in the range of 30 nm≦D≦40 nm.

### 5.3. Experimental Example 2

The pitch P of the Ag particles was set to 80 nm, the thickness T of the Ag particle was set to 12 nm, and the thickness G of the SiO₂ layer was set to 40 nm. Further, the diameter D of the Ag particle was set to 30 nm, 40 nm, 50 nm and 60 nm. Then, the relationship between the excitation frequency and the enhancement was checked. The result is shown in FIG. 13.

It can be understood from FIG. 13 that the peak value (maximum value) of the enhancement is 40 or greater in the models of D=30 nm and 40 nm, which is larger than that in the models of D=50 nm and 60 nm. That is, similar to FIG. 12 of Experimental example 1, it is understood that the enhancement is increased in the range of 30 nm≦D≦40 nm.

Generally, it is known that if the diameter D of the Ag particle is increased and the distance between the adjacent Ag particles is reduced, the localized surface plasmon between the Ag particles becomes strong and the peak value is red-shifted (shifted to the long wavelength side). On the other hand, in the present experimental example, as shown in FIG. 13, as the diameter D is reduced, the peak value is blue-shifted (shifted to the short wavelength side). In addition, as the diameter D is reduced, the enhancement is increased. This is a new phenomenon that the enhancement is increased even though the pitch P of the Ag particles is enlarged to 30 nm, 40 nm, 50 nm and 60 nm and the localized surface plasmon between the Ag particles is weakened.

### 5.4. Experimental Example 3

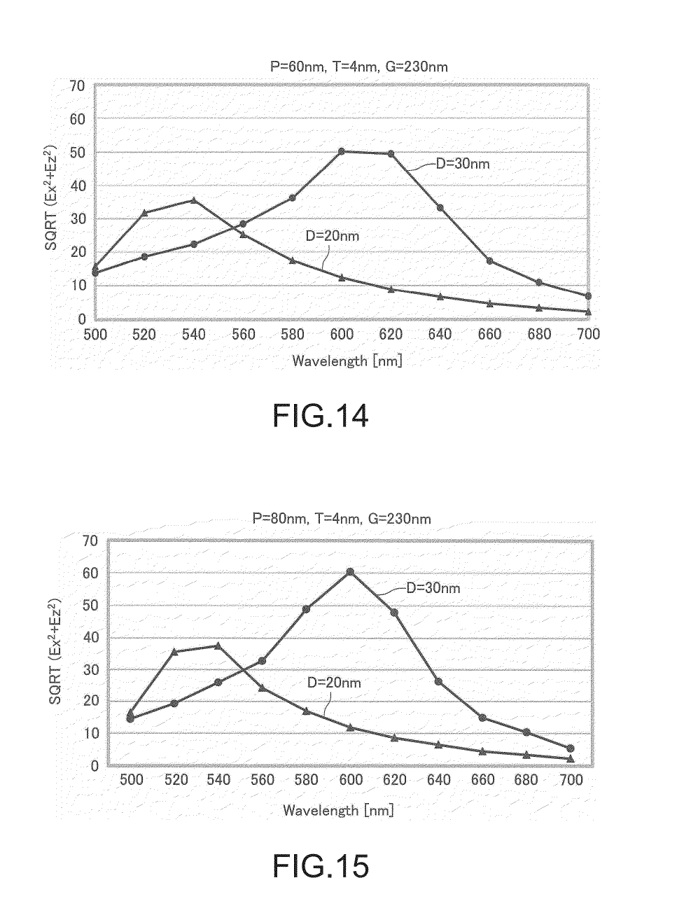

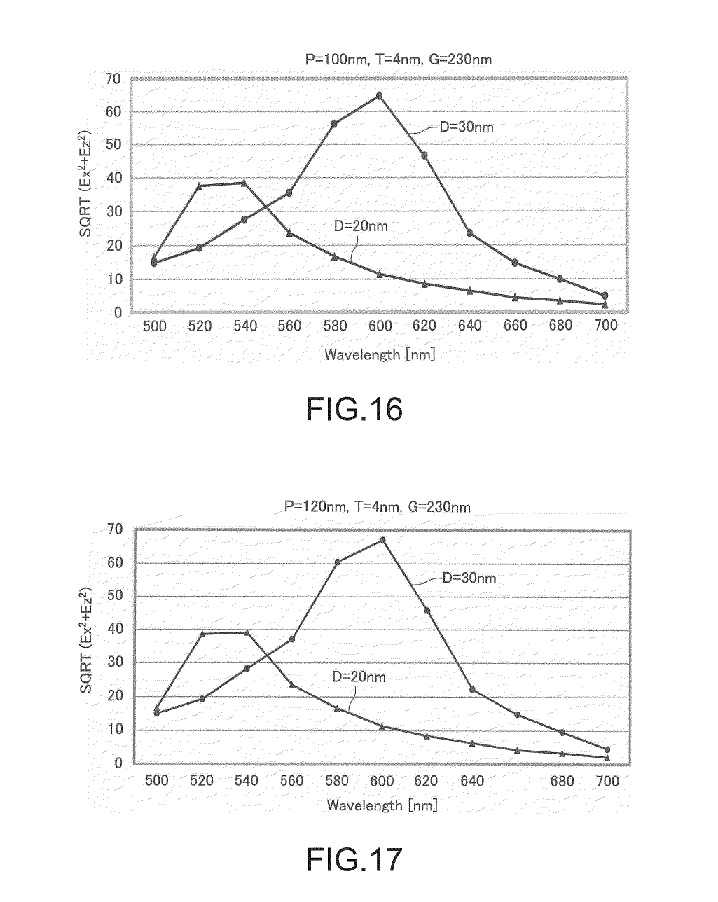

The thickness T of the Ag particle was fixed to 4 nm, and the thickness G of the SiO₂ layer was fixed to 230 nm. Further, the diameter D of the Ag particle was set to 20 nm and 30 nm, the pitch P of the Ag particles was set to 60 nm, 80 nm, 100 nm and 120 nm. Then, the relationship between the excitation wavelength and the enhancement was checked. The results are shown in FIGS. 14 to 17. FIG. 14 shows the result of P=60 nm, FIG. 15 shows the result of P=80 nm, FIG. 16 shows the result of P=100 nm, and FIG. 17 shows the result of P=120 nm.

It can be understood from FIGS. 14 to 17 that the model of D=30 nm has an enhancement peak value of 50 or greater and the enhancement is high compared with the model of D=20 nm, in any pitch P.

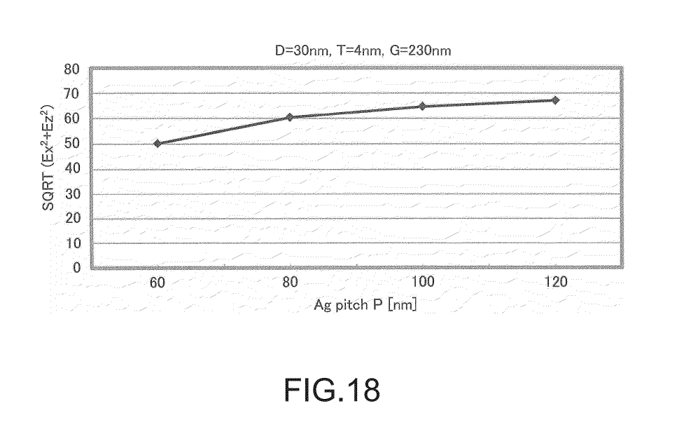

Here, FIG. 18 is a graph illustrating the relationship between the pitch P and the enhancement in the model of D=30 nm shown in FIGS. 14 to 17. It can be understood from FIG. 18 that the enhancement is 50 or greater in the range of 60 nm≦P≦120 nm.

As shown in FIG. 18, the enhancement is monotonically increased as the pitch P is increased. Accordingly, it is naturally expected that the enhancement of the model of P=140 nm is higher than the enhancement of the model of P=120 nm. Accordingly, it is understood that the enhancement is high in the range of 60 nm≦P≦140 nm, and is higher in the range of 100 nm≦P≦140 nm.

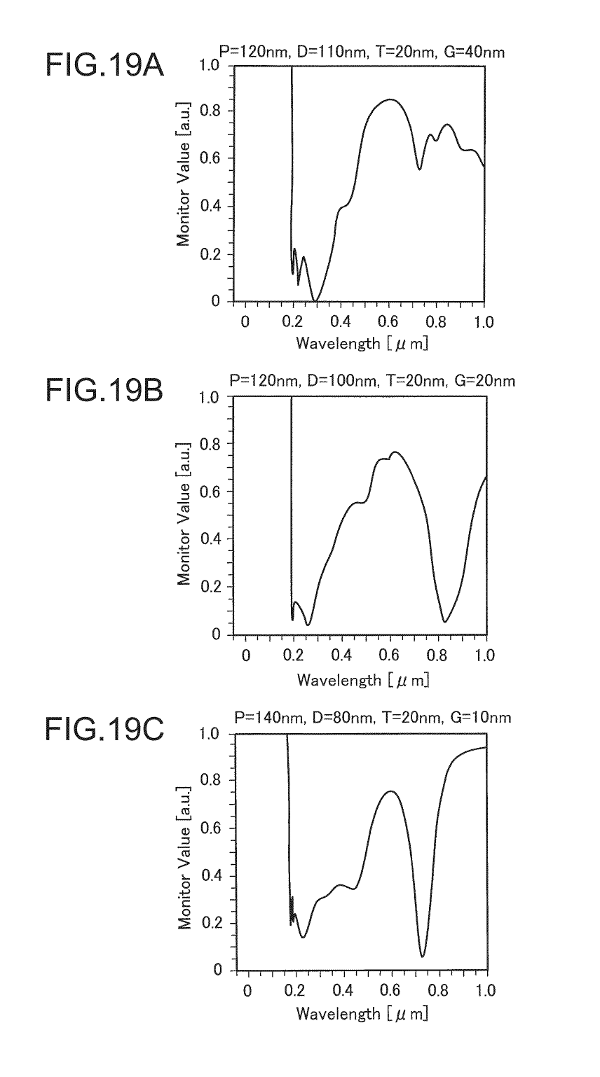

FIGS. 19A to 19C show profiles illustrating the relationship between the excitation wavelength and reflectance of model A (P=120 nm, D=110 nm, T=20 nm and G=40 nm), model B (P=120 nm, D=100 nm, T=20 nm and G=20 nm), and model C (P=140 nm, D=80 nm, T=20 nm and G=10 nm). It is understood from FIGS. 19A to 19C that a wavelength at which the reflectance drops is present even in model C of P=140 nm and a sufficiently high enhancement may be obtained.

FIGS. 19A to 19C show a wavelength characteristic (far field characteristic) of the reflectance of light when the light is incident on the metallic particle 30 and is then reflected from the metallic particle 30. When light is enhanced and closed in a near field, the reflectance of the far field characteristic drops. That is, as shown in model C of P=140 nm shown in FIGS. 19A to 19C, the fact that the reflectance drops in the far field characteristic means that the light is enhanced by the surface plasmons.

The above-described embodiments and modification examples are examples, and the invention is not limited thereto. For example, the respective embodiments and the respective modification examples may be appropriately combined.

The invention includes substantially the same configuration (for example, a configuration having the same function, way and result, or a configuration of the same object and effect) as in the configuration described in the embodiments. Further, the invention includes a configuration in which a part that is not essential in the configuration described in the embodiments is replaced. Further, the invention includes a configuration that achieves the same effect or is capable of achieving the same object as in the configuration described in the embodiments. Further, the invention includes a configuration in which a known technique is added to the configuration described in the embodiments.

The entire disclosure of Japanese Patent Application No. 2013-036768, filed Feb. 27, 2013 is expressly incorporated by reference herein.

What is claimed is:

1. An optical element comprising:
a metal layer in which a first direction is a thickness direction;
a metallic particle that is provided to be spaced from the metal layer in the first direction; and
a light transmitting layer that separates the metallic particle from the metal layer,
wherein the size T of the metallic particle in the first direction satisfies a relationship of 3 nm≦T≦14 nm, and
wherein the size D of the metallic particle in a second direction orthogonal to the first direction satisfies a relationship of 30 nm≦D<50 nm.

2. The optical element according to claim 1,
wherein the size D satisfies a relationship of 30 nm≦D≦40 nm.

3. The optical element according to claim 1,
wherein the size T satisfies a relationship of 3 nm≦T≦6 nm.

4. The optical element according to claim 1,
wherein the metallic particles are disposed in a matrix form with a pitch P in the second direction and a third direction orthogonal to the first direction and the second direction, and
wherein the pitch P satisfies a relationship of 60 nm≦P≦140 nm.

5. The optical element according to claim 1,
wherein the light transmitting layer includes silicon oxide, and
wherein the thickness G of the light transmitting layer in the first direction satisfies a relationship of 10 nm≦G≦150 nm or 200 nm≦G≦350 nm.

6. The optical element according to claim 1,
wherein the light transmitting layer is formed of a dielectric having a positive dielectric constant,
wherein a secondary peak enhancement SQRT is equal to or higher than a primary peak enhancement SQRT, and
wherein the thickness G of the light transmitting layer in the first direction is a thickness at the secondary peak enhancement SQRT.

7. The optical element according to claim 1,
wherein when light having a wavelength larger than the size T and the size D is irradiated, Raman scattering light is enhanced.

8. An analysis equipment comprising:
the optical element according to claim 1;
a light source that irradiates the optical element with light; and
a detector that detects light radiated from the optical element according to light irradiation from the light source.

9. An analysis equipment comprising:
the optical element according to claim 2;
a light source that irradiates the optical element with light; and
a detector that detects light radiated from the optical element according to light irradiation from the light source.

10. An analysis equipment comprising:
the optical element according to claim 3;
a light source that irradiates the optical element with light; and
a detector that detects light radiated from the optical element according to light irradiation from the light source.

11. An analysis equipment comprising:
the optical element according to claim 4;
a light source that irradiates the optical element with light; and
a detector that detects light radiated from the optical element according to light irradiation from the light source.

12. An analysis equipment comprising:
the optical element according to claim 5;
a light source that irradiates the optical element with light; and
a detector that detects light radiated from the optical element according to light irradiation from the light source.

13. An analysis equipment comprising:
the optical element according to claim 6;
a light source that irradiates the optical element with light; and
a detector that detects light radiated from the optical element according to light irradiation from the light source.

14. An analysis equipment comprising:
the optical element according to claim 7;
a light source that irradiates the optical element with light; and
a detector that detects light radiated from the optical element according to light irradiation from the light source.

15. The analysis equipment according to claim 8,
wherein the detector detects Raman scattering light enhanced by the optical element.

16. The analysis equipment according to claim 8,
wherein the light source irradiates the optical element with light having a wavelength larger than the size T and the size D.

17. An analysis method comprising:
irradiating an optical element with light, and
detecting light radiated from the optical element according to the light irradiation to analyze a target,
wherein the optical element includes:
a metal layer in which a first direction is a thickness direction;
a metallic particle that is provided to be spaced from the metal layer in the first direction; and
a light transmitting layer that separates the metallic particle from, the metal layer
wherein the size T of the metallic particle in the first direction satisfies a relationship of 3 nm≦T≦14 nm, and
wherein the size D of the metallic particle in a second direction orthogonal to the first direction satisfies a relationship of 30 nm≦D<50 nm.

18. An electronic apparatus comprising:
the analysis equipment according to claim 8;
an operating section that operates health care information on the basis of detection information from the detector;
a storage section that stores the health care information; and
a display section that displays the health care information.

19. An electronic apparatus comprising:
the analysis equipment according to claim 15;
an operating section that operates health care information on the basis of detection information from the detector;
a storage section that stores the health care information; and
a display section that displays the health care information.

20. The electronic apparatus according to claim 18,
wherein the health care information includes information relating to the presence or absence or amount of at least one type of biologically related substance selected from a group that includes bacillus, virus, protein, nucleic acid, and antigens and antibodies, or at least one type of compound selected from inorganic molecules and organic molecules.
